(19) United States
(12) Patent Application Publication
(10) Pub. No.: US 2026/0200068 A1
(43) Pub. Date: Jul. 16, 2026

(54) HANGABLE TOOL HOLDING FRAME

(71) Applicant: JUI CHIEN KAO, TAICHUNG CITY (TW)

(72) Inventor: JUI CHIEN KAO, TAICHUNG CITY (TW)

(21) Appl. No.: 19/019,380

(22) Filed: Jan. 13, 2025

(51) Int. Cl. B25H 3/04

(52) U.S. Cl. CPC B25H 3/04

(57) ABSTRACT

A hangable tool holding frame has a rack base, a hangable holding part, and a fastener. The rack base has a sliding track extending from a free end thereof. The hangable holding part is detachably secured at the free end of the rack base. The hangable holding part has an end plate closing the free end and the sliding track of the rack base, a secured plate supporting a rear side of the rack base, a standing plate protruding opposite to the rear side from the secured plate, a holding plate extending out of the end plate, a connecting hole formed through the secured plate, and a hanging hole formed through the holding plate. The fastener is inserted in the connecting hole and fastens the hangable holding part to the rack base. The hangable holding part closes the sliding track, is hangable, and can be easily gripped.

### BACKGROUND OF THE INVENTION

### 1. Field of the Invention

The present invention relates to a tool holding frame, and more particularly to a tool holding frame which can be easily hung and gripped.

### 2. Description of the Prior Art

A conventional tool holding frame comprises an elongated track base and multiple tool holding mounts mounted on the track base. The tool holding mounts are configured to hold, clamp, or hang tools, e.g. sockets, wrenches, screw drivers, etc., on the track base, so the tools may be stored conveniently. The track base has two free ends at opposite two ends thereof. Each holding base may be placed into the track base via one of the free ends thereof and may be kept in positions relative to the track base.

However, the conventional tool holding frame is still inconvenient in many ways, for example, the elongated track base may not have any hanging hole to facilitate hanging on a suspending board or a wall. When the track base has many tools put thereon, the track base has no portions suitable for gripping and is difficultly be held by a user. Since the track base has two free ends, when the conventional tool holding frame is subjected to impact or external force, the tool holding mounts adjacent to the two free ends are prone to separate from the track base.

To overcome the shortcomings, the present invention provides a tool holding frame to mitigate or obviate the aforementioned problems.

### SUMMARY OF THE INVENTION

The main objective of the present invention is to provide a hangable tool holding frame that may be hung on a wall or a suspending board for a user to easily fetch tools held on the tool holding frame.

The hangable tool holding frame comprises a rack base, a hangable holding part, and a fastener. The rack base is elongated and comprises a rear side, a free end, and a sliding track extending along a longitudinal direction of the rack base from the free end. The hangable holding part is detachably secured at the free end of the rack base and comprises an end plate closing the free end and the sliding track of the rack base, a secured plate located at a side of the end plate and supporting the rear side of the rack base, a holding plate extending out of the end plate and extending away from the rack base along the longitudinal direction of the rack base, a standing plate protruding from the secured plate and extending away from the rear side of the rack base, a connecting hole formed through the secured plate, and a hanging hole formed through the holding plate. The fastener is inserted in the connecting hole via a side of the secured plate of the hangable holding part opposite to the rack base and fastens the hangable holding part to the rack base. The fastener comprises a rod extending through the connecting hole of the hangable holding part and connected to the rack base and a head formed at an end of the rod and located at the side of the secured plate opposite to the rack base.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a first embodiment of a hangable tool holding frame in accordance with the present invention with tools held thereon;

FIG. 2 is an operational side view of the hangable tool holding frame in FIG. 1;

FIG. 3 is a partial perspective view of the hangable tool holding frame in FIG. 1;

FIG. 4 is a partially enlarged side view in partial section of the hangable tool holding frame in FIG. 1;

FIG. 5 is a perspective view of a hangable holding part of the hangable tool holding frame in FIG. 1;

FIG. 6 is another perspective view of the hangable holding part of the hangable tool holding frame in FIG. 1;

FIG. 7 is an operational perspective view of a second embodiment of a hangable tool holding frame in accordance with the present invention hung on a wall;

FIG. 8 is an operational perspective view of the hangable tool holding frame in FIG. 7;

FIG. 9 is a perspective view of a third embodiment of a hangable holding part of a hangable tool holding frame in accordance with the present invention;

FIG. 10 is another perspective view of the hangable holding part of the hangable tool holding frame in FIG. 9;

FIG. 11 is a perspective view of a fourth embodiment of a hangable holding part of a hangable tool holding frame in accordance with the present invention;

FIG. 12 is another perspective view of the hangable holding part of the hangable tool holding frame in FIG. 11;

FIG. 13 is a perspective view of a fifth embodiment of a hangable holding part of a hangable tool holding frame in accordance with the present invention; and

FIG. 14 is another perspective view of the hangable holding part of the hangable tool holding frame in FIG. 13.

### DETAILED DESCRIPTION OF THE PREFERRED EMBODIMENTS

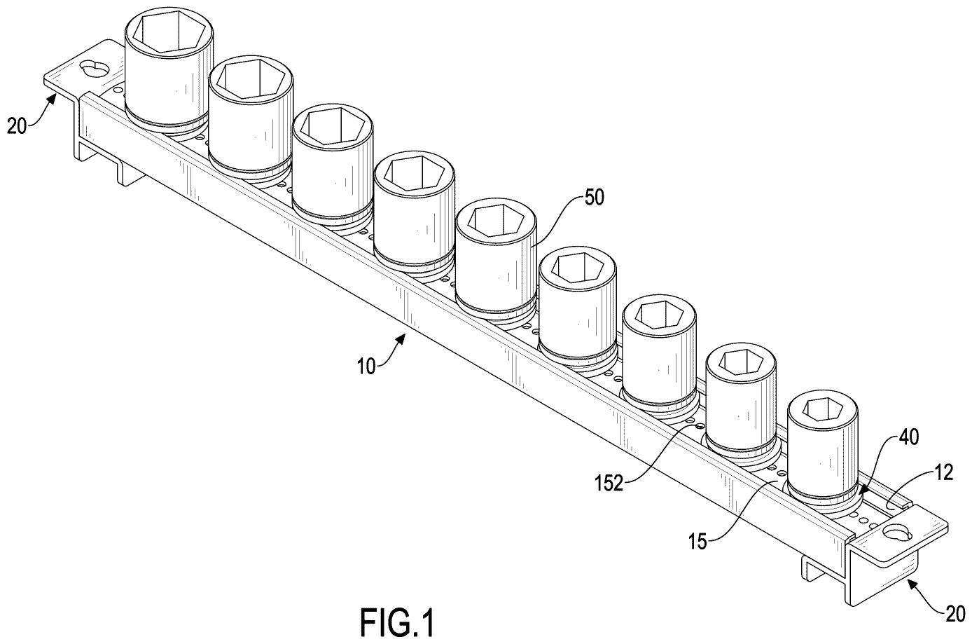

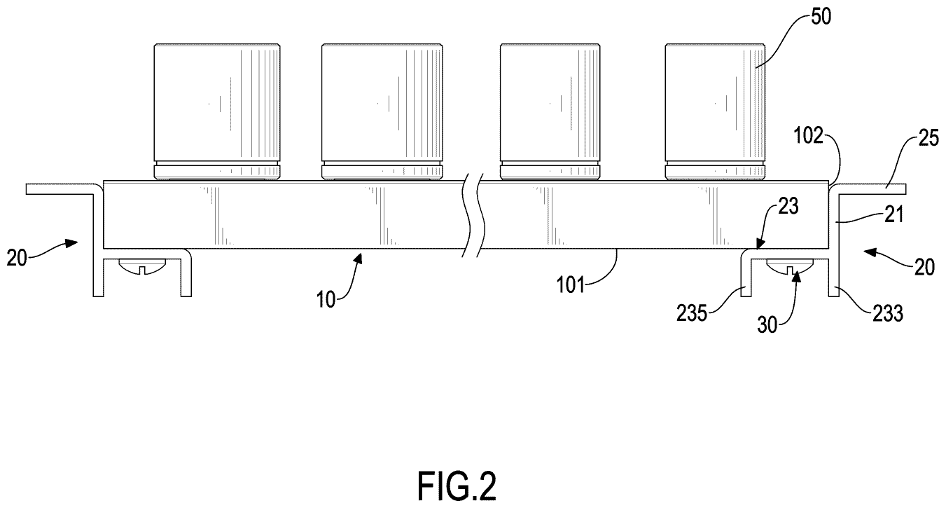

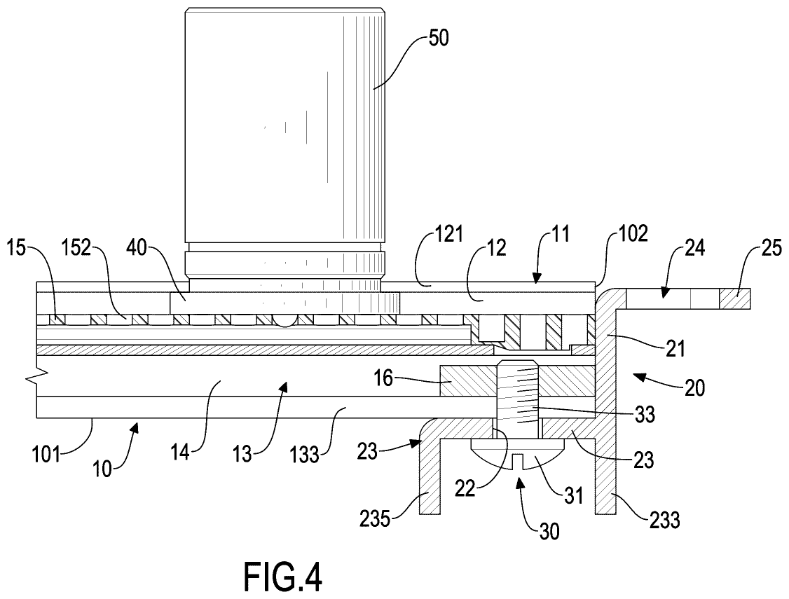

With reference to FIGS. 1 to 4, a first embodiment of a hangable tool holding frame in accordance with the present invention comprises a rack base 10, a hangable holding part 20, and a fastener 30.

The rack base 10 is elongated and is configured to be mounted by multiple tool holding mounts 40 arranged in a single row along the rack base 10. Tools 50, e.g. sockets, screwdrivers, or wrenches may be held, clamped, or hung on the tool holding mounts 40 to be stored on the rack base 10.

The rack base 10 comprises a rear side 101, a free end 102, and a sliding track 12 extending from the free end 102 along a longitudinal direction of the rack base 10. The tool holding mounts 40 may be placed into the sliding track 12 from the free end 102 and is firmly mounted to the rack base 10.

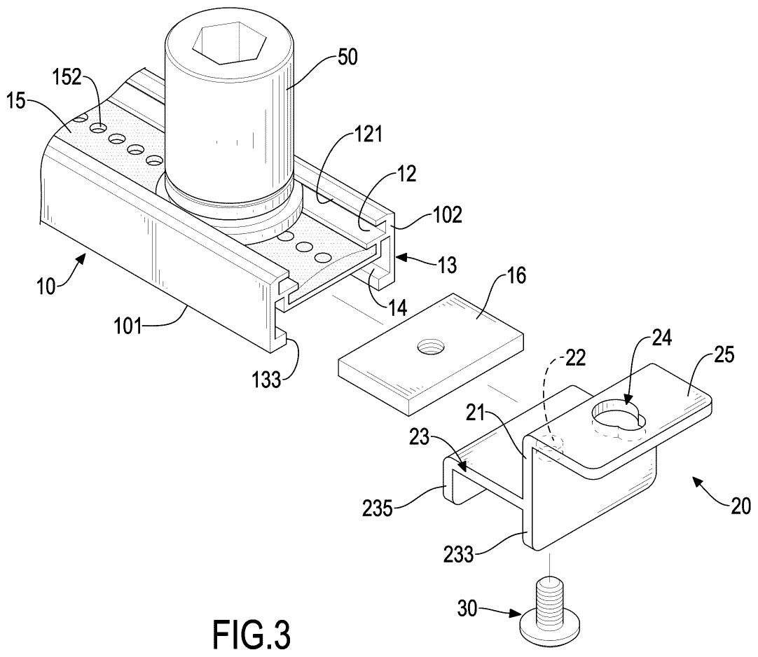

With reference to FIGS. 3 to 6, the hangable holding part 20 is detachably secured at the free end 102 of the rack base 10 and comprises an end plate 21, a secured plate 23, a holding plate 25, a standing plate 233/235, a connecting hole 22, and a hanging hole 24.

The end plate 21 closes the free end 102 and the sliding track 12 of the rack base 10. The secured plate 23 is located at a side of the end plate 21, supports the rear side 101 of the rack base 10, and extends along the longitudinal direction of the rack base 10. The holding plate 25 extends out of the end plate 21 and extends away from the rack base 10 along the longitudinal direction of the rack base 10. The standing plate 233/235 protrudes from the secured plate 23 and extends away from the rear side 101 of the rack base 10. The connecting hole 22 is formed through the secured plate 23. The hanging hole 24 is formed through the holding plate 25.

The fastener 30 is inserted in the connecting hole 22 via a side, opposite to the rack base 10, of the secured plate 23 of the hangable holding part 20 and fastens the hangable holding part 20 to the rack base 10. The fastener 30 may be a bolt and comprises a rod 33 and a head 31 formed at an end of the rod 33. The head 31 is located at the side of the secured plate 23 opposite to the rack base 10. The rod 33 extends through the connecting hole 22 and is connected to the rack base 10.

Specifically, the rack base 10 comprises a track body 11 and a connecting portion 13. The track body 11 is elongated. The sliding track 12 is formed in the track body 11 and extends along the track body 11. The connecting portion 13 is formed at a rear side of the track body 11 and extends along the track body 11. The connecting portion 13 comprises two engaging tabs 133 spaced apart from each other and spaced apart from the track body 11. A connecting channel 14 is formed between the two engaging tabs 133 and the track body 11. A fastening block 16 is placed in the connecting channel 14. The secured plate 23 of the hangable holding part 20 abuts against the two engaging tabs 133. The rod 33 of the fastener 30 is inserted into and screwed with the fastening block 16 to secure the hangable holding part 20 to the connecting portion 13. In another embodiment, the connecting portion may be a block with a threaded hole. The secured plate abuts against the connecting portion. The rod of the fastener is inserted in and screwed with the threaded hole of the connecting portion.

With reference to FIGS. 1 to 4, the free end 102 and the sliding track 12 are closed by the end plate 21 of the hangable holding part 20 to prevent the tool holding mount 40 from separating from the rack base 10 via the free end 102. The hangable tool holding frame may be hung on a hook or a nail via the hanging hole 24 formed through the holding plate 25. Since the hangable holding part 20 is mounted at the free end 102 of the rack base 10, the overall width of the hangable tool holding frame is free from increasing. In addition, a user may grip the holding plate 25 to hold the hangable tool holding frame. In addition, the head 31 of the fastener 30 is prevented from directly contacting a table surface or a wall surface by the standing plate 233/235.

Preferably, the hangable holding part 20 may comprise two said standing plates 233, 235 spaced apart from each other and are respectively located at diametrically opposite sides of the connecting hole 22 and the fastener 30. The hangable tool holding frame may stably stand on the table via the two standing plates 233, 235 of the hangable holding part 20. The head 31 of the fastener 30 is prevented from directly contacting the table surface with the two standing plates 233, 235. The hanging hole 24 comprises a large end 241 and a small end 242 being smaller than the large end 241 in width. The hook may be easily inserted into the hanging hole 24 via the large end 24 and supports the small end 242 of the hanging hole 24 to prevent the hangable tool holding frame from being detached from the hook.

Preferably, the hangable tool holding frame comprises two said hangable holding parts 20 and two said fasteners 30. The rack base 10 comprises two free ends 102. The sliding track 12 extends from one of the two free ends 102 to the other one of the two free ends 102. The two hangable holding parts 20 are detachably mounted at the two free ends 102 of the rack base 10. The two fasteners 30 are respectively inserted through the connecting holes 22 of the secured plates 23 of the two hangable holding parts 20 to respectively secure the two hangable holding parts 20 to the rack base 10.

Since the hangable tool holding frame comprises two said hangable holding parts 20, the user may conveniently take the hangable tool holding frame being elongated with his/her two hands respectively gripping the holding plates 25 of the two hangable holding parts 20. To hang the hangable tool holding frame, the hangable tool holding frame may be transversally hung on the wall or the suspending board via two hooks transversally spaced apart from each other and inserted into the two hanging holes 24 of the two hangable holding parts 20, whereby the user may easily take tools hung on the hangable holding frame. In addition, the hangable tool holding frame may stably stand on the table via the standing plates 233, 235 of the two hangable holding parts 20.

With reference to FIGS. 1 to 4, in the first embodiment, the rack base 10 may be made of a metallic material, e.g. aluminum extrusion. The track body 11 may comprise a positioning board 15 and two front rail tabs 121. The two front rail tabs 121 are respectively located at opposite two sides of the track body 11 and is in front of and spaced apart from the positioning board 15. The sliding track 12 is formed between the positioning board 15 and the two front rail tabs 121. The positioning board 15 has multiple positioning structures 152 arranged along the longitudinal direction of the rack base 10 at spaced intervals. Each tool holding mount 40 is slidable along the sliding track 12 and is rotatable relative to the track body 11. Each tool holding mount 40 is configured to engage with one of the positioning structures 152 to be kept in position. Each positioning structure 152 may be a positioning hole or a positioning protrusion. Each tool holding mount 40 may be configured to hold a socket.

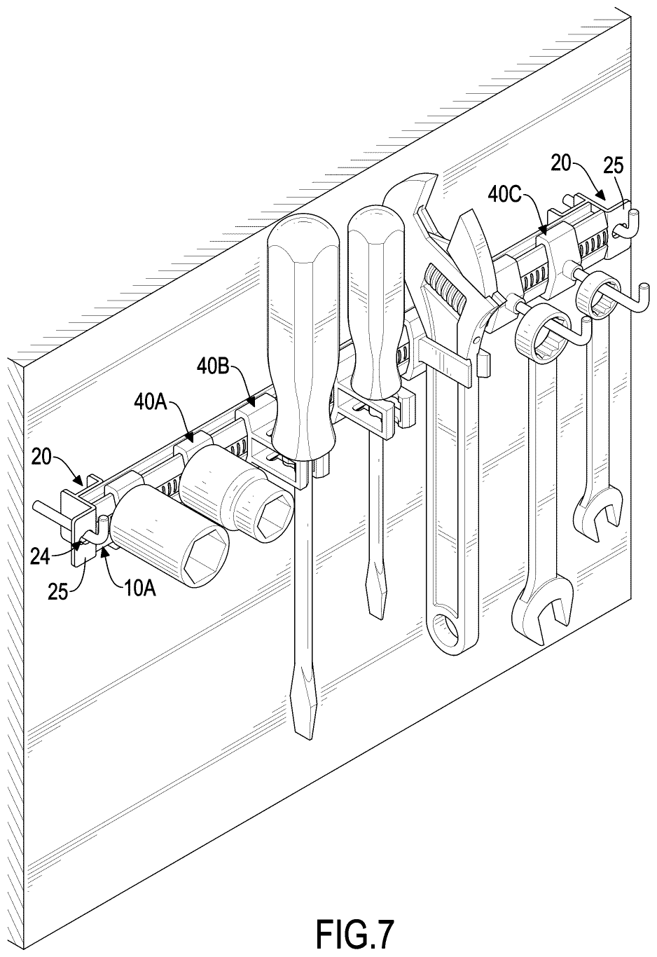

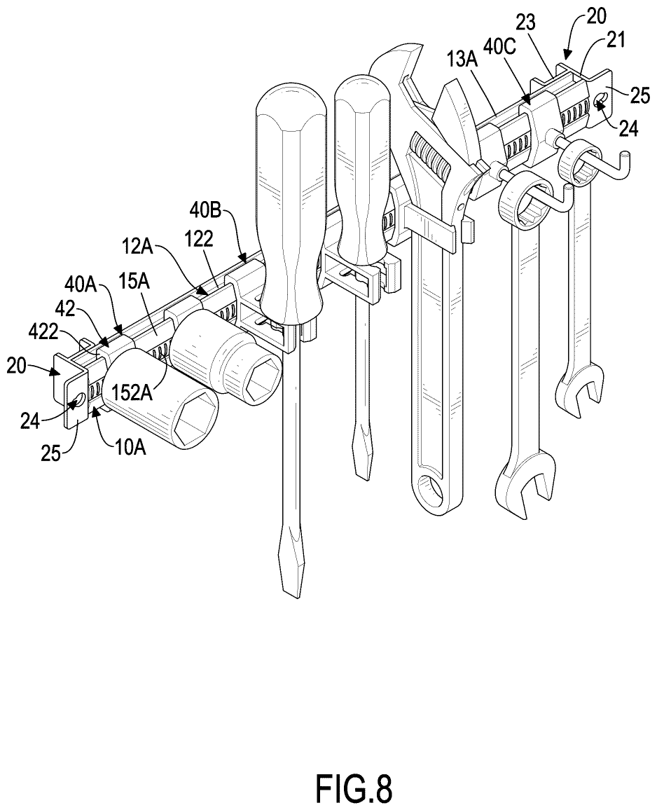

With reference to FIGS. 7 and 8, in the second embodiment, the rack base 10A may be made of a plastic material and comprises a positioning board 15A and a back panel 13A. The positioning board 15A has multiple positioning structures 152A arranged along the longitudinal direction of the rack base 10A. Each positioning structure 152A may be a curved recess. The sliding track 12A is formed between the positioning board 15A and the back panel 13A and comprises two track channels 122 at opposite two sides of the rack base 10A and having openings opposite to each other. The secured plate 23 of the hangable holding parts 20 abuts against the back panel 13A. Each tool holding mount 40A/40B/40C is mounted to and is slidable relative to the rack base 10A along the positioning board 15A. Each tool holding mount 40A/40B/40C comprises a clamping portion 42 and a holding portion. The clamping portion 42 comprises two hooking portions 422 respectively formed at opposite two sides thereof and respectively extending into the two track channels 122. The holding portion is formed on a side of the clamping portion 42 opposite to the positioning board 15A and is configured to receive or to clamp the hand tool or to hang the hand tool thereon.

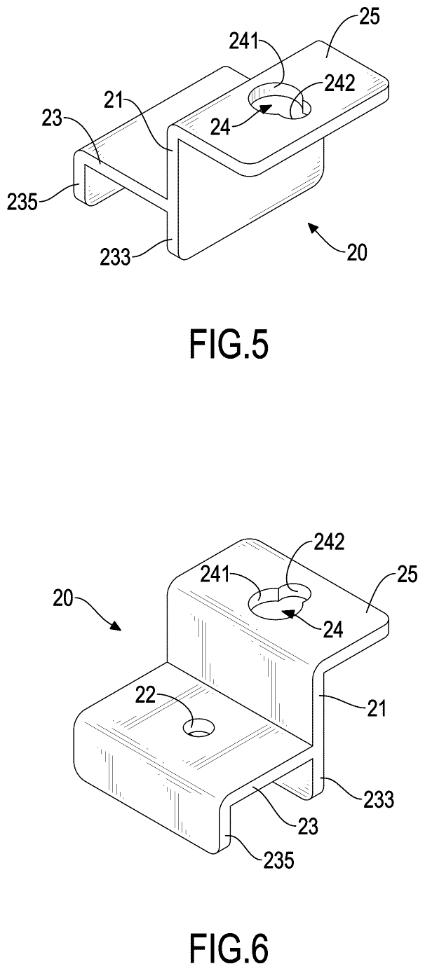

With reference to FIGS. 5 and 6, in the first embodiment, the hangable holding part 20 may comprise two said standing plates 233, 235 respectively at opposite two ends of the secured plate 23 and extending backwardly. That is, the standing plates 233, 235 extend opposite to the rear side 101 of the rack base 10. One of the two standing plates 233 extends backwardly from an end of the end plate 21 and protrudes from the secured plate 23. The other one of the two standing plates 235 extends backwardly from the end, away from the end plate 21, of the secured plate 23. The holding plate 25 protrudes from the end plate 21 and extends away from the rack base 10. The holding plate 25 is located at an end, away from the secured plate 23, of the end plate 21.

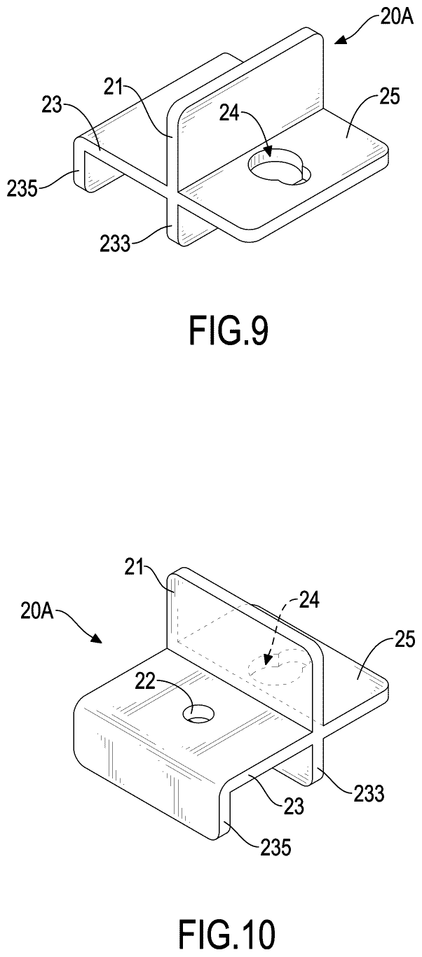

With reference to FIGS. 9 and 10, in the third embodiment, the hangable holding part 20A comprises two standing plates 233, 235. One of the two standing plates 233 extends backwardly from an end of the end plate 21 and protrudes from the secured plate 23. The other one of the two standing plates 235 extends backwardly from the end, away from the end plate 21, of the secured plate 23. That is, the two standing plates 235 extend opposite to the rear side of the rack base. The holding plate 25 protrudes from the end plate 21 and extends away from the rack base and is spaced apart from respective ends, away from the secured plate 23, of the end plate 21 and the standing plate 233.

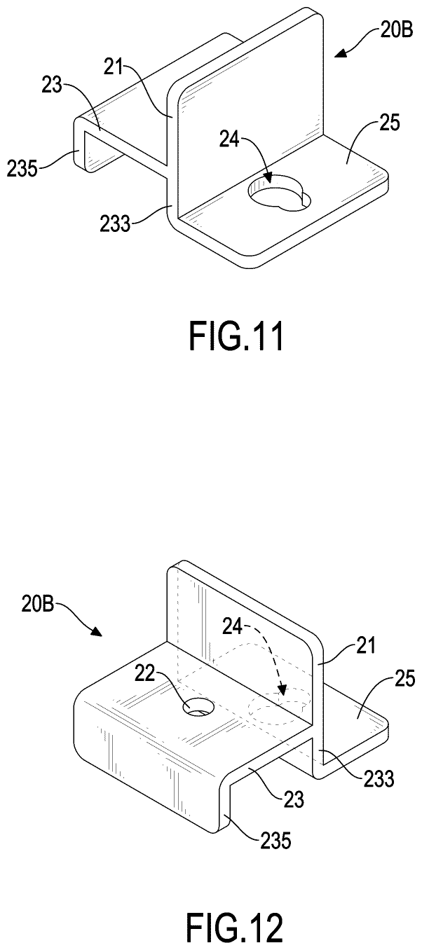

With reference to FIGS. 11 and 12, in the fourth embodiment, the hangable holding part 20B comprises two standing plates 233, 235 extending opposite to the rear side of the rack base. One of the two standing plates 233 extends backwardly from an end of the end plate 21 and protrudes from the secured plate 23. The other one of the two standing plates 235 extends backwardly from the end, away from the end plate 21, of the secured plate 23. The holding plate 25 protrudes from the standing plate 233 adjacent to the end plate 21, extends away from the rack base, and extends out of the end plate 21. The holding plate 25 is located at the end, away from the secured plate 23, of the standing plate 233.

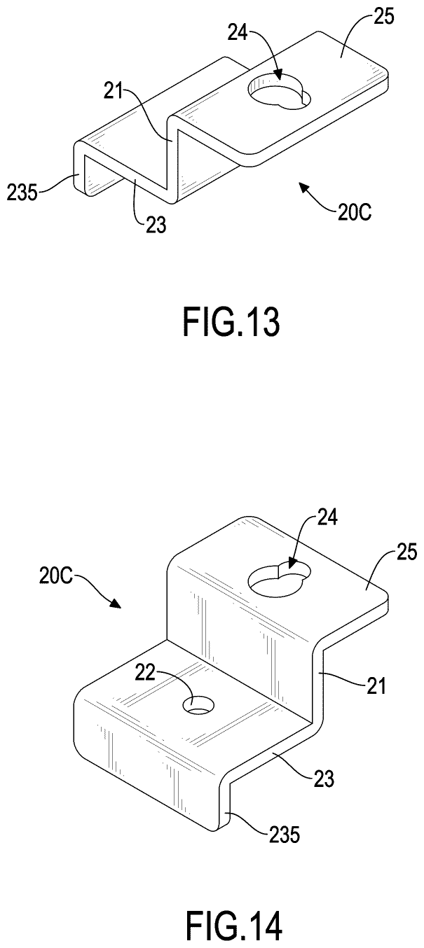

With reference to FIGS. 13 and 14, in the fifth embodiment, the hangable holding part 20C comprises one standing plate 235 extending opposite to the rear side of the rack base. The standing plates 235 extend backwardly from the end of the secured plate 23 away from the end plate 21. The holding plate 25 protrudes from the end, away from the secured plate 23, of the end plate 21 and extends away from the rack base. In another embodiment, the standing plate may extend backwardly from the end of the end plate and extend out of the secured plate. The holding plate may be connected to the end plate to be located near a front of the rack base or be connected to the standing plate to be located near a rear of the rack base.

With such arrangements, the hangable holding part 20 is secured at the free end 102 of the rack base 10 via the fastener 30 inserted from the rear side of the rack base 10, and the hangable holding part 20 is detachably and firmly fixed to the rack base 10 without increasing the overall width of the hangable tool holding frame. The tool holding mount 40 may be placed into the sliding track 12 via the free end 102, and then the hangable holding part 20 is secured at the free end 102 of the rack base 10 to close the sliding track 12 via the end plate 21 thereof. The tool holding mount 40 cannot be easily detached from the rack base 10. The holding plate 25 extending away from the rack base 10 provides a holding portion to be easily gripped by a user's hand. The hangable tool holding frame may be hung on the wall or the suspending board via the hanging hole 24 at the holding plate 25. The head 31 of the fastener 30 can be protected by the standing plate 233/235 without directly contacting the wall or the table. The hangable tool holding frame may be stably placed on the table by the standing plates 233,235 of the hangable holding parts 20 at the opposite free ends 102 of the rack base 10.

What is claimed is:

1. A hangable tool holding frame comprising:
a rack base being elongated and comprising
a rear side;
a free end; and
a sliding track extending along a longitudinal direction of the rack base from the free end;
a hangable holding part detachably secured at the free end of the rack base and comprising
an end plate closing the free end and the sliding track of the rack base;
a secured plate located at a side of the end plate and supporting the rear side of the rack base;
a holding plate extending out of the end plate and extending away from the rack base along the longitudinal direction of the rack base;
a standing plate protruding from the secured plate and extending away from the rear side of the rack base;
a connecting hole formed through the secured plate; and
a hanging hole formed through the holding plate; and
a fastener inserted in the connecting hole via a side, opposite to the rack base, of the secured plate of the hangable holding part to fasten the hangable holding part to the rack base and comprising
a rod extending through the connecting hole of the hangable holding part and connected to the rack base; and
a head formed at an end of the rod and located at the side of the secured plate opposite to the rack base.

2. The hangable tool holding frame as claimed in claim 1, wherein the holding plate of the hangable holding part protrudes from an end, away from the secured plate, of the end plate.

3. The hangable tool holding frame as claimed in claim 1, wherein the holding plate of the hangable holding part protrudes from the standing plate and extends out of the end plate.

4. The hangable tool holding frame as claimed in claim 1, wherein the holding plate of the hangable holding part is spaced apart from respective ends, away from the secured plate, of the end plate and the standing plate.

5. The hangable tool holding frame as claimed in claim 1, wherein the standing plate of the hangable holding part extends opposite to the rear side of the rack base from the end plate.

6. The hangable tool holding frame as claimed in claim 1, wherein the standing plate of the hangable holding part extends opposite to the rear side of the rack base from an end, away from the end plate, of the secured plate.

7. The hangable tool holding frame as claimed in claim 1, wherein the hangable holding part comprises an additional said standing plate, and the two standing plates are spaced apart from each other and respectively located at diametrically opposite sides of the connecting hole.

8. The hangable tool holding frame as claimed in claim 1, wherein the hanging hole of the hangable holding part comprises a large end and a small end being smaller than the large end in width.

9. A hangable tool holding frame comprising:
a rack base being elongated and comprising
a rear side;
two free ends; and
a sliding track extending along a longitudinal direction of the rack base from one of the two free ends to the other one of the two free ends;
two hangable holding parts detachably secured at the two free ends of the rack base respectively and each of the two hangable holding parts comprising
an end plate closing a respective one of the two free ends and the sliding track of the rack base;
a secured plate located at a side of the end plate and supporting the rear side of the rack base;
a holding plate extending out of the end plate and extending away from the rack base along the longitudinal direction of the rack base;
a standing plate protruding from the secured plate and extending away from the rear side of the rack base;
a connecting hole formed through the secured plate; and
a hanging hole formed through the holding plate; and
two fasteners respectively fixing the two hangable holding parts to the rack base, each of the two fasteners inserted in the connecting hole of a respective one of the two hangable holding parts via a side, opposite to the rack base, of the secured plate of the respective one hangable holding part, each of the two fasteners comprising
a rod extending through the connecting hole of the respective one of the two hangable holding parts and connected to the rack base; and
a head formed at an end of the rod and located at the side, opposite to the rack base, of the secured plate.

10. The hangable tool holding frame as claimed in claim 9, wherein the holding plate of each one of the two hangable holding parts protrudes from an end, away from the secured plate of the hangable holding part, of the end plate of the hangable holding part.

11. The hangable tool holding frame as claimed in claim 9, wherein the holding plate of each one of the two hangable holding parts protrudes from the standing plate of the hangable holding part and extends out of the end plate of the hangable holding part.

12. The hangable tool holding frame as claimed in claim 9, wherein the holding plate of each one of the two hangable holding parts is spaced apart from respective ends, away from the secured plate, of the end plate of the hangable holding part and the standing plate of the hangable holding part.

13. The hangable tool holding frame as claimed in claim 9, wherein the standing plate of each one of the two hangable holding parts extends opposite to the rear side of the rack base from the end plate.

14. The hangable tool holding frame as claimed in claim 9, wherein the standing plate of each one of the two hangable holding parts extends opposite to the rear side of the rack base from an end, away from the end plate of the hangable holding part, of the secured plate of the hangable holding part.

15. The hangable tool holding frame as claimed in claim 9, wherein each one of the two hangable holding parts comprises an additional said standing plate, and the two standing plates of the hangable holding part are spaced apart from each other and respectively located at diametrically opposite sides of the connecting hole of the hangable holding part.

16. The hangable tool holding frame as claimed in claim 9, wherein the hanging hole of each one of the two hangable holding parts comprises a large end and a small end being smaller than the large end in width.
